(19) United States
(12) Patent Application Publication
(10) Pub. No.: US 2025/0303210 A1
(43) Pub. Date: Oct. 2, 2025

(54) FLUORINE FREE FIREFIGHTING FOAM COMPOSITIONS FOR LOW TEMPERATURE APPLICATIONS

(71) Applicant: PERIMETER SOLUTIONS LP, Clayton, MO (US)

(72) Inventors: Leilei ZHANG, Green Bay, WI (US); Carlson SUGIARTO, Green Bay, WI (US); Pamela HAVELKA-RIVARD, De Pere, WI (US); Melissa KIM, Ontario, CA (US); Marcela MUNOZ, Fontana, CA (US); Daniel MORAGA, Rancho Cucamonga, CA (US)

(21) Appl. No.: 19/092,518

(22) Filed: Mar. 27, 2025

Related U.S. Application Data
(60) Provisional application No. 63/571,709, filed on Mar. 29, 2024.

(51) Int. Cl. A62D 1/02

(52) U.S. Cl. CPC A62D 1/0071

(57) ABSTRACT

The present invention is directed to firefighting foam compositions (e.g., concentrates, foam forming compositions, and solutions) exhibiting improved low temperature stability and/or suitable for use as Class A foams, high expansion foams and in vehicle systems.

### REFERENCE TO RELATED APPLICATIONS

This application claims the benefit of, and priority to, U.S. Provisional Patent Application Ser. No. 63/571,709, filed Mar. 29, 2024, the entire contents of which are hereby incorporated by reference for all relevant purposes and as if fully set forth herein.

### FIELD OF THE INVENTION

The present invention involves firefighting foam compositions (e.g., concentrates, premixes, foam forming compositions, and solutions) exhibiting improved low temperature stability and/or suitable for use as Class A foams, high expansion foams and in vehicle systems.

### BACKGROUND OF THE INVENTION

Aqueous firefighting foams are used against Class A fires involving ordinary combustible materials such as wood, cloth, paper, rubber, and many plastics. Effective Class A firefighting foams, including fluorine-free foams are known.

Although effective Class A foams have been developed, opportunities exist for improvement and/or to provide alternative Class A foams. For example, one opportunity for improvement involves low temperature stability and performance.

Other foam compositions, including fluorine-free foams, are known for use as high expansion foams and for use in vehicle fire extinguishing systems. Opportunities for improvement exist in connection with these compositions as well.

### BRIEF SUMMARY OF THE INVENTION

Various aspects of the present invention are directed to firefighting foam compositions exhibiting improved low temperature stability.

Various such embodiments are directed to (fluorine-free) firefighting foam compositions, the composition comprising: water; a surfactant component comprising: (i) one or more branched chain surfactants selected from anionic surfactants, amphoteric surfactants, and combinations thereof and (ii) one or more linear chain surfactants selected from anionic surfactants, amphoteric surfactants, and combinations thereof; a solvent component comprising one or more solvents, wherein the one or more solvents are selected from the group consisting of fatty alcohols, alcohols, glycols, glycol ethers, terpenes, and combinations thereof. The composition is in the form of a firefighting foam concentrate having a freezing point below 2° C. (35° F.); or the composition is in the form of a firefighting foam premix that is a flowable liquid at low temperatures (e.g., temperatures of 0° C. or below, −10° C. or below, −20° C. or below, −30° C. or below, or −40° C. or below), and the weight ratio of branched chain surfactants to linear chain surfactants in the surfactant component is at least about 1:1, at least about 1.5:1, at least about 2:1, at least about 2.5:1, or at least about 3:1.

Other such embodiments are directed to (fluorine-free) firefighting foam compositions, the composition comprising: water; a surfactant component comprising one or more anionic surfactants, one or more amphoteric surfactants, and combinations thereof; a solvent component comprising: (i) one or more branched chain solvents selected from the group consisting of fatty alcohols, alcohols, glycols, glycol ethers, and combinations thereof; and (ii) one or more linear chain solvents selected from the group consisting of fatty alcohols, alcohols, glycols, glycol ethers, and combinations thereof. The composition is in the form of a firefighting foam concentrate having a freezing point below 2° C. (35° F.); or the composition is in the form of a firefighting foam premix that is a flowable liquid at low temperatures (e.g., temperatures of 0° C. or below, −10° C. or below, −20° C. or below, −30° C. or below, or −40° C. or below), and the weight ratio of branched chain solvents to linear chain solvents in the solvent component is at least about 1:1, at least about 1.5:1, at least about 2:1, at least about 2.5:1, or at least about 3:1.

Other embodiments of the present invention are directed to (fluorine-free) firefighting foam compositions, the composition comprising: a surfactant component comprising one or more anionic surfactants, one or more amphoteric surfactants, and combinations thereof; a solvent component comprising one or more solvents, wherein the one or more solvents are selected from the group consisting of fatty alcohols, alcohols, glycols, glycol ethers, terpenes (e.g., d-limonene), and combinations thereof. The composition is in the form of a firefighting foam concentrate having a freezing point below 2° C. (35° F.); and/or the composition is in the form of a firefighting foam premix that is a flowable liquid at low temperatures (e.g., temperatures of 0° C. or below, −10° C. or below, −20° C. or below, −30° C. or below, or −40° C. or below). The solvent component comprises one or more the following: (i) one or more fatty alcohols, in a total proportion of from about 0.2 wt % to about 3.5 wt % of the solvent component, and/or (ii) one or more alcohols, in a total proportion of from about 0.25 wt % to about 4.0 wt % of the solvent component, and/or (iii) one or more glycols, in a total proportion of from about 5 wt % to about 30 wt % of the solvent component, and/or (iv) one or more glycol ethers, in a total proportion of from about 2 wt % to about 20 wt % of the solvent component, and/or (v) one or more terpenes (d-limonene) in a total proportion of from about 0.2 wt % to about 6 wt % of the solvent component.

Still further embodiments of the present invention are directed to (fluorine-free) firefighting foam concentrate compositions, the compositions comprising: water; a surfactant component comprising one or more anionic surfactants, one or more amphoteric surfactants, and combinations thereof; a solvent component comprising d-limonene and one or more solvents are selected from the group consisting of fatty alcohols, glycols, glycol ethers, and combinations thereof; wherein d-limonene constitutes from about 0.1 wt % to about 2 wt % of the foam concentrate.

Various embodiments of the present invention are directed to foam compositions that may be particularly suited for use in Class A foams along with other applications.

Various such embodiments include (fluorine-free) firefighting foam concentrate compositions, the compositions comprising: water; a surfactant component comprising one or more anionic surfactants, one or more amphoteric surfactants, and combinations thereof; a solvent component comprising one or more solvents are selected from the group consisting of fatty alcohols, glycols, glycol ethers, terpenes, and combinations thereof; wherein anionic surfactants constitute at least about 50 wt % of the surfactant component.

Other such embodiments include (fluorine-free) firefighting foam concentrate compositions, the compositions comprising: water; a surfactant component comprising one or more anionic surfactants, one or more amphoteric surfactants, and combinations thereof; a solvent component comprising one or more solvents selected from the group consisting of fatty alcohols, glycols, glycol ethers, terpenes, and combinations thereof; wherein: the weight ratio of anionic surfactant to amphoteric surfactant in the surfactant component is from about 60:40 to about 40:60, from about 55:45 to about 45:55, or about 50:50.

Still further such embodiments are directed to (fluorine-free) firefighting foam concentrate compositions, the compositions comprising: water; d-limonene in a proportion of from about 0.1 wt % to about 10 wt % of the concentrate; a surfactant component comprising one or more anionic surfactants, one or more amphoteric surfactants, and combinations thereof; and a solvent component comprising one or more solvents selected from the group consisting of fatty alcohols, glycols, glycol ethers, and combinations thereof. The compositions comprise: from about 0.1 wt % to about 5 wt % of one or more alcohol or fatty alcohols; from about 1 wt % to about 60 wt % of glycol ether solvents; from about 25 wt % to about 60 wt % of anionic surfactants; and from about 10 wt % to about 40 wt % amphoteric surfactants; and wherein the composition exhibits 1% Drave Test Wetting Results of at least about or at least 8 seconds(s).

Still further embodiments of the present invention are directed to (fluorine-free) high expansion firefighting foams, the compositions comprising: a surfactant component consisting of one or more anionic surfactants, and one or more amphoteric surfactants, wherein the anionic surfactants constitute from about 15 wt % to about 60 wt % of the composition, and the amphoteric surfactants constitute from about 20 wt % to about 50 wt % of the composition; and the composition exhibits an expansion ratio of at least about 200, at least about 400, at least about 600, or at least about 800.

Other aspects of the present invention are directed to compositions suitable for use in extinguishing vehicle fires. Such compositions may be used as foam compositions that pass vehicle system fire testing conducted at −40° C.

Various such embodiments are directed to (fluorine-free) firefighting foam concentrate composition, the composition comprising: water; d-limonene in a proportion of from about 0.1 wt % to about 3 wt % of the concentrate; a surfactant component comprising one or more anionic surfactants, one or more amphoteric surfactants, and combinations thereof; and a solvent component comprising one or more solvents selected from the group consisting of fatty alcohols, glycols, glycol ethers, and combinations thereof. The composition comprises from about 0.1 wt % to about 5 wt % of one or more alcohols or fatty alcohols; from about 1 wt % to about 60 wt % of glycol ether solvents; from about 1 wt % to about 10 wt % of anionic surfactants; and from about 10 wt % to about 60 wt % amphoteric surfactants.

Other such embodiments are directed to (fluorine-free) firefighting foam concentrate composition, the composition comprising: water; d-limonene in a proportion of from about 0.1 wt % to about 3 wt % of the concentrate; a surfactant component consisting of one or more amphoteric surfactants, and combinations thereof; and a solvent component comprising one or more solvents selected from the group consisting of fatty alcohols, glycols, glycol ethers, and combinations thereof. The composition comprises: from about 0.1 wt % to about 5 wt % of one or more alcohols or fatty alcohols; from about 1 wt % to about 60 wt % of glycol ether solvents; and from about 10 wt % to about 60 wt % amphoteric surfactants.

Aspects of the present invention are also directed to firefighting foam premixes, the premixes containing from about 0.5 wt % to about 2 wt % of a composition of the present disclosure, from about 30 wt % to about 60 wt % of a premix solvent, and water, wherein the premix is a flowable liquid below temperatures of 0° C., −10° C., −20° C., −30° C., or −40° C.

Other objects and features will be in part apparent and in part pointed out hereinafter.

### BRIEF DESCRIPTION OF THE FIGURES

FIG. 1 provides a graphical representation of the effect of incorporating certain solvents and/or branched components (e.g., surfactants, solvents, alcohols) in accordance with the present invention.

FIG. 2 displays the effect on foam concentrate freezing point by incorporating one or more branched chain components.

FIG. 3 displays the effect of incorporating various solvents or solvent combinations on foam concentrate freezing point in accordance with the present invention.

FIG. 4 displays the effect on foam premix freezing point at −40° C. of incorporating certain solvents or solvent combinations in accordance with the present invention.

FIG. 5 provides the results of high expansion foam testing described in Example 1.

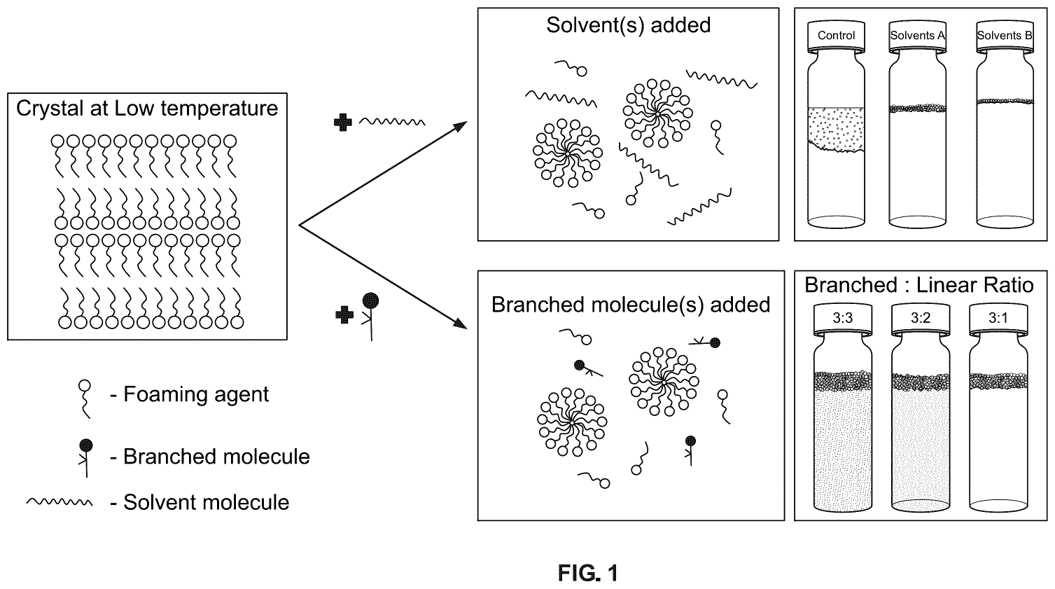

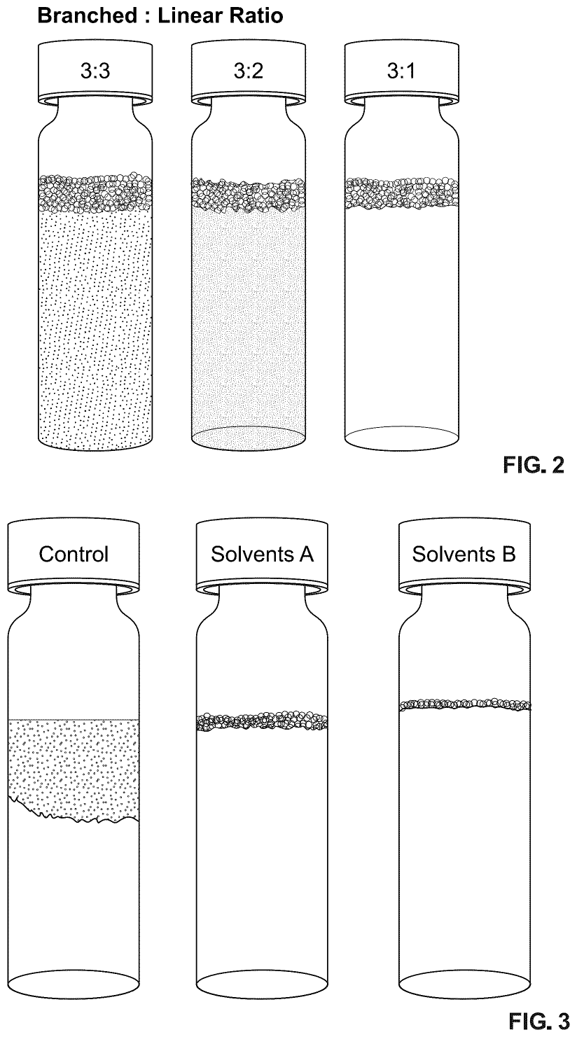

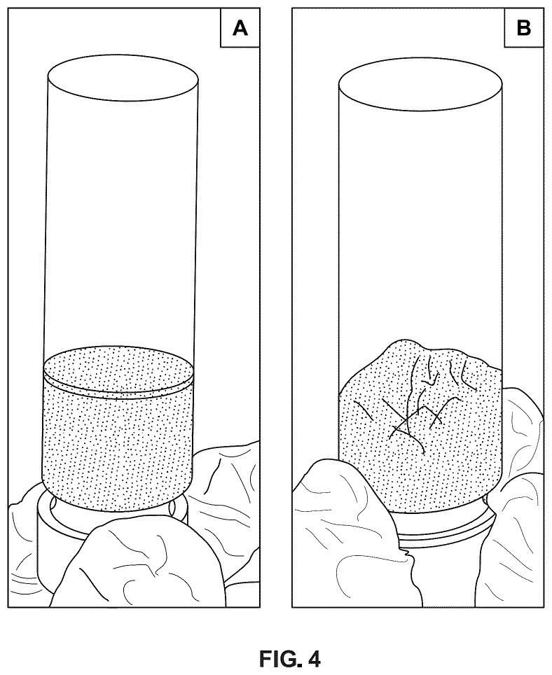

### DETAILED DESCRIPTION OF THE INVENTION

Generally, the present invention is directed to firefighting foam compositions suitable for use in a variety of applications and exhibiting one or more improvements and/or enhanced performance properties. Firefighting foam compositions described herein include firefighting foam concentrates, firefighting foam premixes (e.g., diluted concentrates), firefighting foam solutions, and firefighting foams (i.e., aspirated firefighting foam solutions).

The compositions of the present invention generally include one or more solvents, one or more surfactants, and optionally other components (e.g., a terpene such as d-limonene or various alcohols) that may also be referred to as solvents herein. The following description provides various examples of such components, concentrations, relative proportions, etc. and examples for use in certain applications. It is to be understood that reference(s) to a certain component or composition as suitable for use in a particular application or as providing a certain performance improvement are not limiting. For example, components or compositions suitable for use in Class A foams exhibiting, for example, improved low temperature stability may also be suitable for use in high expansion foams or in vehicle fire extinguishing systems.

### Surfactants

Generally, the compositions of the present invention include one or more anionic surfactants, one or more amphoteric (zwitterionic) surfactants, and combinations thereof.

### Anionic Surfactants

Suitable anionic surfactants generally include sulfate surfactants, sulfonate surfactants, and combinations thereof.

Suitable sulfate surfactants include branched and/or linear alkoxylated (e.g., ethoxylated) sulfate surfactants, and salts thereof, and amine sulfate surfactants.

For example, suitable alkyl sulfate surfactants include C8-C22, C8-C16, C8-C12, and C10-C12 alkyl sulfate surfactants, and salts thereof.

Suitable salts include ammonium, alkali metal (e.g., sodium), and alkaline earth (e.g., magnesium) salts. Other suitable salts include amine salts and ethanolamine salts (e.g., triethanolamine, TEA, salts) and phosphate salts.

With reference to a firefighting foam concentrate, the total proportion of anionic surfactant may be at least about 5 wt %, at least about 10 wt %, at least about 15 wt %, at least about 20 wt %, at least about 25 wt %, at least about 30 wt %, at least about 35 wt %, at least about 40 wt %, or even at least about 50 wt %,

In various embodiments, the total proportion of anionic surfactant in the foam concentrate may be less than about 60 wt %, less than about 50 wt %, or less than about 40 wt % and above any of the foregoing lower limits.

### Amphoteric (Zwitterionic) Surfactants

Suitable amphoteric surfactants include propionate surfactants, iminopropionate surfactants, betaine surfactants, sultaine surfactants, amine oxide surfactants, and salts thereof.

Suitable propionate surfactants include C6-C14 alkyl-iminodipropionate surfactants, and salts thereof. For example, suitable propionate surfactants include sodium octyliminodipropionate surfactants. Other suitable propionate surfactants include alkylamphopropionate surfactants.

Suitable betaine surfactants include C8-C22 betaine surfactants. For example, suitable betaine surfactants include lauramidopropyl betaine, cocamidopropyl betaine, and combinations thereof.

Suitable sultaine surfactants include C8-C22 sultaine surfactants.

With reference to a firefighting foam concentrate, the total proportion of amphoteric surfactant may be at least about 5 wt %, at least about 10 wt %, at least about 15 wt %, at least about 20 wt %, at least about 25 wt %, at least about 30 wt %, at least about 35 wt %, at least about 40 wt %, or even at least about 50 wt %.

In various embodiments, the total proportion of amphoteric surfactant in the foam concentrate may be less than about 60 wt %, less than about 50 wt %, or less than about 40 wt % and above any of the foregoing lower limits.

### Branched Chain Surfactants

In accordance with various aspects of the present invention, it has been discovered that incorporation of certain branched chain surfactants and/or in certain proportions may provide various advantageous properties. For example, it is currently believed that incorporating certain branched chain surfactants and/or certain amounts of branched chain surfactants provides improvements in low temperature properties. These include lower freezing points and remaining as a flowable liquid at relatively low temperatures.

As discussed herein, improvements in low temperature properties may be indicated by the freezing point of a firefighting foam concentrate of less than about 10° C., less than about 5° C., less than about 2° C., or even less than about 0° C.

Low temperature performance may also be indicated by compositions (e.g., foam premixes) being flowable liquids at relatively low temperatures (e.g., below temperatures of 0° C., −10° C., −20° C., −30° C., or −40° C.). Foam premix compositions as discussed herein generally include a diluted concentrate (e.g., a composition of the present invention as defined herein) diluted with a solvent (e.g., a premix solvent) and water. For example, certain premix compositions contain from about 0.5 wt % to about 2 wt % (e.g., about 1 wt %) of a composition of the present invention and a premix solvent (e.g., from about 30 wt % to about 60 wt % or from about 40 wt % to about 60 wt % of a premix solvent) and water. Suitable proportions of water in a premix composition are from about 30 wt % to about 80 wt %, or from about 40 wt % to about 70 wt %. Suitable premix solvents include those generally known in the art, including the solvents listed elsewhere herein.

In various embodiments, the composition comprises a surfactant component comprising one or more branched chain surfactants selected from anionic surfactants, amphoteric surfactants, and combinations thereof. Typically, in accordance with such embodiments, the composition further comprises one or more linear chain surfactants selected from anionic surfactants, amphoteric surfactants, and combinations thereof.

In accordance with various embodiments, the weight ratio of branched chain surfactants to linear chain surfactants in the surfactant component is at least about 1:1, at least about 1.5:1, at least about 2:1, at least about 2.5:1, or at least about 3:1. Typically, the weight ratio of branched chain surfactants to linear chain surfactants in the surfactant component is less than about 5:1, less than about 3:1, or less than about 1.5:1.

In various embodiments, the composition includes at least about 0.5 wt % branched chain anionic surfactants, or from about 1.2 wt % to about 8 wt % branched chain anionic surfactants. More specifically, the surfactant component may include at least about 10 wt %, at least about 20 wt %, at least about 30 wt %, at least about 40 wt %, or at least about 50 wt % of branched chain anionic surfactants (and/or in a proportion of less than about 90 wt %, less than about 80 wt %, less than about 70 wt %, less than about 60 wt %, or less than about 50 wt % of the surfactant component). Suitable branched chain anionic surfactants include sulfate surfactants, ethoxylated sulfate surfactants, phosphate sulfate surfactants, and combinations thereof.

In accordance with these and various other embodiments, the composition typically comprises at least about 0.5 wt % branched chain amphoteric (zwitterionic) surfactants, or from about 1 wt % to about 20 wt % branched chain amphoteric (zwitterionic) surfactants. Suitable branched chain surfactants include betaine surfactants, iminopropionate surfactants, sultaine surfactants, and combinations thereof.

More specifically, the surfactant component may include at least about 10 wt %, at least about 20 wt %, at least about 30 wt %, at least about 40 wt %, or at least about 50 wt % of branched chain amphoteric surfactants (and/or in a proportion of less than about 90 wt %, less than about 80 wt %, less than about 70 wt %, less than about 60 wt %, or less than about 50 wt % of the surfactant component).

As noted, the compositions further typically contain one or more linear chain surfactants and the surfactant component may comprise at least about 0.5 wt % linear chain anionic surfactants, from about 5 wt % to about 60 wt %, or from about 8 wt % to about 55 wt % linear chain anionic surfactants. Suitable linear chain anionic surfactants may be selected from the group consisting of sulfate surfactants, ethoxylated sulfate surfactants, phosphate sulfate surfactants, and combinations thereof.

More specifically, the surfactant component may include at least about 10 wt %, at least about 20 wt %, at least about 30 wt %, at least about 40 wt %, or at least about 50 wt % of linear chain anionic surfactants (and/or in a proportion of less than about 90 wt %, less than about 80 wt %, less than about 70 wt %, less than about 60 wt %, or less than about 50 wt % of the surfactant component).

The surfactant component may also comprise at least about 5 wt % linear chain amphoteric surfactants, from about 5 wt % to about 40 wt %, or from about 8 wt % to about 35 wt % linear chain amphoteric surfactants. Suitable linear chain amphoteric surfactants are selected from the group consisting of betaine surfactants, iminopropionate surfactants, sultaine surfactants, and combinations thereof.

More specifically, the surfactant component may include at least about 10 wt %, at least about 20 wt %, at least about 30 wt %, at least about 40 wt %, or at least about 50 wt % of linear chain amphoteric surfactants (and/or in a proportion of less than about 90 wt %, less than about 80 wt %, less than about 70 wt %, less than about 60 wt %, or less than about 50 wt % of the surfactant component).

### Organic Solvents

Further in accordance with the present invention, the compositions of the present invention include one or more solvents that may constitute a solvent component comprised by the composition.

Typically, the solvent component is selected from fatty alcohols, alcohols, glycols, glycol ethers, terpenes, and combinations thereof.

Suitable fatty alcohols include those containing from 6 to 14 carbon atoms (i.e., C6-C14 fatty alcohols). Typically, one or more fatty alcohols may be present in the composition in a proportion of from about 0.2 wt % to about 3.5 wt %. The solvent component may include at least about 10 wt %, at least about 20 wt %, at least about 30 wt %, at least about 40 wt %, or at least about 50 wt % of one or more fatty alcohols (and/or in a proportion of less than about 90 wt %, less than about 80 wt %, less than about 70 wt %, less than about 60 wt %, or less than about 50 wt % of the solvent component).

Suitable alcohols include C4-C8 alkyl alcohols (linear and/or branched), and combinations thereof. One or more alcohols are typically present in the composition in a proportion of from about 0.25 wt % to about 4.0 wt %. Suitable alcohols include butanol and octanol. The solvent component may include at least about 10 wt %, at least about 20 wt %, at least about 30 wt %, at least about 40 wt %, or at least about 50 wt % of one or more alcohols (and/or in a proportion of less than about 90 wt %, less than about 80 wt %, less than about 70 wt %, less than about 60 wt %, or less than about 50 wt % of the solvent component).

Suitable glycols include propylene glycol, hexylene glycol, and combinations thereof. The glycols may be present in a proportion of from about 5 wt % to about 30 wt % of the composition. The solvent component may include at least about 10 wt %, at least about 20 wt %, at least about 30 wt %, at least about 40 wt %, or at least about 50 wt % of one or more glycols (and/or in a proportion of less than about 90 wt %, less than about 80 wt %, less than about 70 wt %, less than about 60 wt %, or less than about 50 wt % of the solvent component).

Suitable glycol ethers include butyl ether, 2-butoxyethanol, butyl carbitol, and combinations thereof. These ethers may be present in a proportion of from about 2 wt % to about 20 wt % of the composition. In various preferred embodiments, the solvent comprises butyl carbitol. The solvent component may include at least about 10 wt %, at least about 20 wt %, at least about 30 wt %, at least about 40 wt %, or at least about 50 wt % of one or more glycol ethers (and/or in a proportion of less than about 90 wt %, less than about 80 wt %, less than about 70 wt %, less than about 60 wt %, or less than about 50 wt % of the solvent component).

Suitable terpenes may be selected from the group consisting of d-limonene, pinene, myrcene, terpinene, p-cymene, and combinations thereof. The one or more terpenes may be present in a total proportion of from about 0.2 wt % to about 6 wt % of the solvent component. In various preferred embodiments, d-limonene is incorporated as a solvent. The solvent component may include at least about 10 wt %, at least about 20 wt %, at least about 30 wt %, at least about 40 wt %, or at least about 50 wt % of one or more terpenes (and/or in a proportion of less than about 90 wt %, less than about 80 wt %, less than about 70 wt %, less than about 60 wt %, or less than about 50 wt % of the solvent component).

Incorporation of branched chain solvents (e.g., one or more alcohols) also has been observed to provide various advantageous properties, including low temperature performance.

For example, various aspects of the present invention involve compositions including a solvent component comprising one or more branched chain solvents selected from the group consisting of fatty alcohols, alcohols, glycols, glycol ethers, and combinations thereof; and one or more linear chain solvents selected from the group consisting of fatty alcohols, alcohols, glycols, glycol ethers, and combinations thereof.

Typically, the weight ratio of branched chain solvents to linear chain solvents in the solvent component is at least about 1:1, at least about 1.5:1, at least about 2:1, at least about 2.5:1, or at least about 3:1. Generally, the weight ratio of branched chain solvents to linear chain solvents in the solvent component is less than about 5:1, less than about 2:1, or less than about 1.5:1.

In accordance with such embodiments, the branched chain solvents typically are selected from the group consisting of hexylene glycol, propylene glycol n-butyl ether (PnB), d-limonene, and combinations thereof. Suitable linear chain solvents in these and other embodiments, include butyl carbitol, ethylene glycol, polyethylene glycol, and combinations thereof.

In accordance with the present invention, it has been discovered that selecting various combinations of solvents may provide improved low temperature performance, regardless of incorporating any branched solvents. For example, such selections may provide a composition in the form of a firefighting foam concentrate having a freezing point below 2° C. (35° F.); and/or a firefighting foam premix that is a flowable liquid at low temperatures (e.g., temperatures of 0° C. or below, −10° C. or below, −20° C. or below, −30° C. or below, or −40° C. or below).

Accordingly, various embodiments of the present invention involve compositions exhibiting improved low temperature performance where the composition comprises a solvent component comprising one or more solvents selected from the group consisting of fatty alcohols, alcohols, glycols, glycol ethers, terpenes (d-limonene), and combinations thereof; where the solvent component comprises one or more of: (i) one or more fatty alcohols, in a total proportion of from about 0.2 wt % to about 3.5 wt % of the solvent component, and/or (ii) one or more alcohols, in a total proportion of from about 0.25 wt % to about 4.0 wt % of the solvent component, and/or (iii) one or more glycols, in a total proportion of from about 5 wt % to about 30 wt % of the solvent component, and/or (iv) one or more glycol ethers, in a total proportion of from about 2 wt % to about 20 wt % of the solvent component, and/or (v) one or more terpenes (d-limonene) in a total proportion of from about 0.2 wt % to about 6 wt % of the solvent component.

In accordance with various preferred embodiments, the solvent component comprises one or more branched or linear alcohols, d-limonene, and glycol ether(s). In these and various other preferred embodiments, the solvent comprises butyl carbitol.

In accordance with these and other embodiments of the present invention, various compositions of the present invention have been observed to be effective low temperature compositions in the absence of any salts incorporated. Various embodiments are thus directed to salt-free (organic and inorganic salts) low temperature compositions. For example, various prior compositions may incorporate an organic salt such as potassium acetate to enhance low temperature performance (e.g., freeze protection). Compositions of the present invention do not adopt such an approach for low temperature, rather the compositions of the present invention include salt-free compositions providing low temperature performance/freeze protection.

### Surfactant and Solvent Combinations

The present invention further includes various compositions combining one or more of the components discussed above.

Various such embodiments are directed to firefighting foam concentrate compositions comprising water; a surfactant component comprising one or more anionic surfactants, one or more amphoteric surfactants, and combinations thereof; and a solvent component comprising d-limonene (e.g., from about 0.1 wt % to about 2 wt %) and one or more solvents are selected from the group consisting of fatty alcohols, glycols, glycol ethers, and combinations thereof. Typically, along with d-limonene the solvent component further comprises a glycol ether solvent selected from the group consisting of butyl carbitol, propylene glycol n-butyl ether (PnB), and combinations thereof.

Such compositions may comprise from about 0.1 to about 1.0 wt % fatty alcohols; from about 15 wt % to about 30 wt % of glycol ether solvents; from about 30 wt % to about 40 wt % amphoteric surfactants; and from about 15 wt % to about 25 wt % of anionic surfactants.

Other compositions may comprise from about 15 wt % to about 30 wt % of glycol ether solvents; from about 20 wt % to about 30 wt % amphoteric surfactants; and from about 20 wt % to about 30 wt % of anionic surfactants.

These and other compositions may comprise from about 0.1 to about 2.5 wt % fatty alcohols; from about 15 wt % to about 30 wt % of glycol ether solvents; from about 10 wt % to about 20 wt % amphoteric surfactants; and from about 45 wt % to about 65 wt % of anionic surfactants.

Various other embodiments may comprise from about 0.1 to about 3.5 wt % fatty alcohols; from about 15 wt % to about 30 wt % of glycol ether solvents; and from about 45 wt % to about 65 wt % of anionic surfactants.

Other compositions of the present invention may comprise a surfactant component comprising one or more anionic surfactants, one or more amphoteric surfactants, and combinations thereof; a solvent component comprising one or more solvents are selected from the group consisting of fatty alcohols, glycols, glycol ethers, terpenes, and combinations thereof wherein the anionic surfactants constitute a significant portion the surfactant component, or even nearly all or all of the surfactant component (e.g., at least about 75 wt %, at least about 80 wt %, at least about 85 wt %, at least about 90 wt %, at least about 95 wt %, even about 99 wt %). Such compositions may be particularly suitable for use in Class A foams.

Other embodiments of the present invention include only amphoteric (zwitterionic) surfactants but do not include any anionic surfactants.

Other compositions of the present invention include concentrate compositions comprising a surfactant component comprising one or more anionic surfactants, one or more amphoteric surfactants, and combinations thereof, where the weight ratio of anionic surfactant to amphoteric surfactant in the surfactant component is from about 60:40 to about 40:60, from about 55:45 to about 45:55, or about 50:50 and/or the surfactant component constitutes at least about 70 wt %, at least about 75 wt %, at least about 80 wt %, or at least about 85 wt % of the composition. These compositions have also been observed to be suitable for use in Class A foams.

### Class A Foam (Concentrates)

As noted, various embodiments of the present invention are directed to compositions, including concentrates, suitable for use in connection with Class A foams.

Various such compositions include d-limonene in a proportion of from about 0.1 wt % to about 10 wt % of the concentrate; from about 0.1 wt % to about 5 wt % of one or more alcohol or fatty alcohols; from about 1 wt % to about 60 wt % of glycol ether solvents; from about 25 wt % to about 60 wt % of anionic surfactants; and from about 10 wt % to about 40 wt % amphoteric surfactants.

Such compositions have been observed to exhibit improved wetting properties, e.g., Drave Test wetting results reported elsewhere herein.

### High Expansion Foams

Various embodiments of the present invention are directed to fluorine-free high expansion firefighting foams. These compositions typically include a surfactant component containing one or more anionic surfactants, and one or more amphoteric surfactants. The anionic surfactants constitute from about 15 wt % to about 60 wt % of the composition, and the amphoteric surfactants constitute from about 20 wt % to about 50 wt % of the composition. More typically, these compositions do not contain any ionic or nonionic surfactants and therefore the surfactant component consists essentially of or consists of anionic and amphoteric surfactants.

High expansion foams of the present invention have been observed under testing to exhibit expansion ratios of at least about 200, at least about 400, at least about 600, or at least about 800.

### Vehicle System Foams

Other compositions of the present invention are suitable for extinguishing fires in vehicle systems. These and other compositions of the present invention may be used in onboard firefighting systems such as those included in heavy equipment. Such heavy equipment may be used in construction, forestry, mining, and other similar industries. Generally, such compositions include d-limonene as a solvent and may include only an amphoteric (zwitterionic) surfactant in the surfactant component.

Various such embodiments include d-limonene in a proportion of from about 0.1 wt % to about 3 wt % of the concentrate; and a surfactant component comprising one or more anionic surfactants, one or more amphoteric surfactants, and combinations thereof; and a solvent component comprising one or more solvents selected from the group consisting of fatty alcohols, glycols, glycol ethers, and combinations thereof.

In accordance with certain embodiments, the composition comprises from about 0.1 wt % to about 5 wt % of one or more alcohols or fatty alcohols; from about 1 wt % to about 60 wt % of glycol ether solvents; from about 1 wt % to about 10 wt % of anionic surfactants; and from about 10 wt % to about 60 wt % amphoteric surfactants.

In other such embodiments, the composition only includes amphoteric (zwitterionic) surfactants (i.e., the surfactant component consists essentially of or consists of one or more amphoteric surfactants) and the composition further includes one or more alcohol or fatty alcohols (e.g., from about 0.1 wt % to about 5 wt % of one or more alcohols or fatty alcohols); one or more glycol ether solvents (e.g., from about 1 wt % to about 60 wt %). The amphoteric (zwitterionic) surfactants typically constitute from about 10 wt % to about 60 wt % of the composition.

### Foam Solutions

Typically, foam solutions of the present invention contain at least or about 0.5 wt %, 1 wt %, 1.5%, 2 wt %, 3 wt %, 4 wt %, 5 wt %, or 6 wt % of the foam concentrate. That is, the foam solutions (i.e., premixes) are typically prepared from the foam concentrate by dilution with water at a dilution ratio (concentrate: water) of from 1:99 to 6:94. Test results reporting herein referring to foams as, for example 1%, 2%, etc. refer to the concentrate concentration in the solution (i.e., the rate of dilution of the concentrate).

### Foams

The compositions of the present invention are typically in the form of a concentrate and provided in equipment suitable for generation of foam. Suitable foam generating equipment includes aspirated foam generating devices, non-aspirated foam generating devices, foam chambers, and sprinkler systems.

Generally, the foams of the present invention are prepared by aspirating a foam solution of the present invention. Advantageously, the foams of the present invention are suitable for use with low expansion foam equipment and medium and high expansion foam discharge devices.

### Methods for Fighting Fires

Various compositions of the present invention are suitable for use as Class A foams. Class A foams increase the effectiveness of water for direct suppression and mop up and can be used in both aerial and ground operations.

It is further currently believed that certain embodiments of the present invention are suitable as Class-A/B foams, in particular fluorine-free Class-A/B foams. Class A/B foam can be used in multiple applications ranging from structural and residential fires; wildland fires; general facilities protection; Class A hazards (ordinary combustible materials such as wood, cloth, paper, rubber, and many plastics); Class B hazards that are not fuel in depth; (e.g., vehicle fires) and foam training exercises. Thus, various embodiments of the present invention are directed to firefighting foam concentrates suitable for use in forming Class-A and/or Class-A/B foams and the foams produced from such concentrates. For example, please see the experimental results below in connection with the compositions of Formulation C in Example 1 and the testing results in extinguishing vehicle fires.

More generally, the foam compositions of the present invention are particularly suitable for use in fire prevention, fire suppression and extinguishment, vapor suppression, and wetting of surfaces.

Described herein are fluorine-free firefighting compositions, e.g., concentrates, foam solutions, premixes, foam-forming solutions, and foams. Fluorine-free may refer to and typically refers to compositions that do not include fluorine. Fluorine-free may also refer to compositions that do not include any fluorinated compound, such as a fluorinated surfactant, and polymers. In various embodiments, the compositions may be nearly entirely free of fluorine, or essentially free of fluorine. In such instances, the composition does not include added fluorine or fluorine-containing compounds. However, although not preferred, water or components of the compositions of the invention may include some minor portion of fluorine, but the compositions are nonetheless “fluorine-free” as defined herein and as understood in the art. Overall, any minor portion of fluorine does not exceed 1 part per trillion (ppt) or 0.1 ppt of the composition.

### EXAMPLES

The following non-limiting examples are provided to further illustrate the present invention.

### Example 1

The following table lists exemplary formulations of the present invention, identified as Formulations A, B, and C.

| Formulation | A | B | C |
|---|---|---|---|
| C6-C14 Alcohol (wt %) | 0-5 | | 0-5 |
| d-Limonene (wt %) | 0-7 | | 0-2 |
| Butyl Carbitol (wt %) | 4-35 | | 4-35 |
| Propylene glycol n-butyl ether | 0-25 | | 0-25 |
| (PnB) (wt %) | | | |
| Sulfate surfactant (C10-C16) | 25-60 | 15-60 | 0-5 |
| (wt %) | | | |
| Betaine (C10-C16) (wt %) | 10-35 | 20-50 | 10-35 |
| Other amphoteric surfactant(s) | 0-5 | | 0-12 |
| (wt %) | | | |
| Water | To 100% | To 100% | To 100% |

Foams of Formulation A were subjected to drave wetting testing to determine suitability for use as a Class A foam. The compositions were tested at a concentration of 1 wt % (i.e., 1 wt % of the Formulation A and 99 wt % water).

| Formulation A | A series |
|---|---|
| 1% Drave Test Wetting Time (sec) | 9~12 |

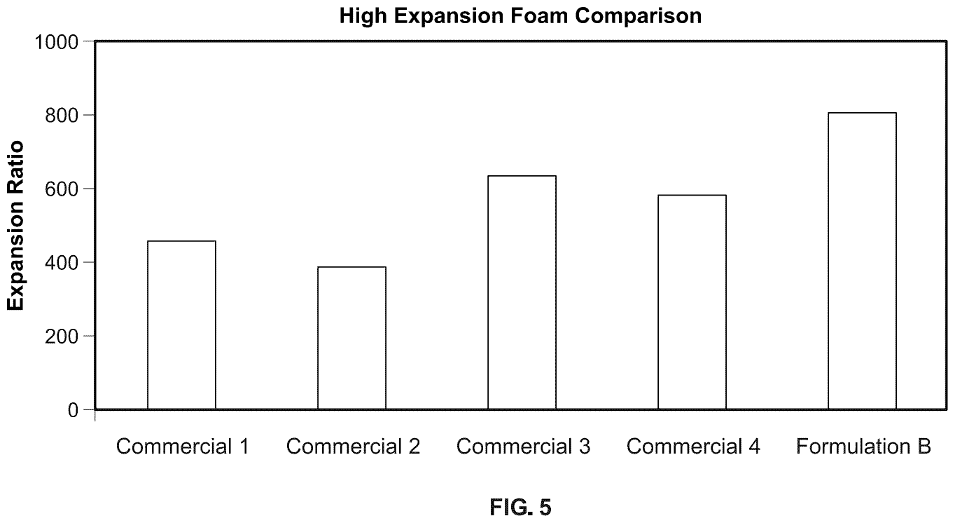

Foams of Formulation B were subjected to high expansion foam testing. The results of the high expansion foam testing are shown in are shown in FIG. 5.

Foams of Formulation C were subjected to vehicle system fire extinguishing testing at concentrations of 3 wt % (3 wt % of Formulation C composition in 97 wt % water).

| Sample | Concentration, % | Fire test | Comment |
|---|---|---|---|
| C | 3 | Extinguish in | Tested at −40° C. |
| | | 7″ | |

### Example 2

The following Table provides additional exemplary formulations of the present invention.

The results listed are for compositions having a concentration of the listed solution of 1 wt % and subjected to: (i) blender expansion ratio testing; (ii) blender quarter drain time (QDT) testing, and (iii) wetting testing.

| Composition | 1 | 2 | 3 | 4 | 5 | 6 | 7 |
|---|---|---|---|---|---|---|---|
| Fatty Alcohol (wt %) | 0.1-2 | | 0.1-5 | | | 0.1-5 | |
| d-Limonene (wt %) | 0.1-2 | 0.1-2 | 0.1-2 | | | 0.1-5 | |
| Butanol (wt %) | | | | 0.1-3 | | | 0.1-5 |
| Octanol (wt %) | | | | 0.1-3 | | | 0.1-5 |
| Butyl Carbitol (wt %) | 10-25 | 10-30 | 5-30 | 15-40 | 5-20 | 5-25 | 5-20 |
| Propylene glycol n- | 1-10 | | | | | 10-25 | 10-25 |
| butyl ether (PnB) (wt %) | | | | | | | |
| AOS14-16(39.3% | | | 15-60 | 15-60 | | 20-60 | 20-60 |
| Actives) (wt %) | | | | | | | |
| Lauramidopropyl betaine | 15-40 | 15-40 | 10-35 | 5-25 | 20-60 | | |
| (LMB) (wt %) | | | | | | | |
| Sodium lauryl sulfate | 10-25 | 15-40 | | | 20-60 | | |
| (wt %) | | | | | | | |
| Sodium octyl sulfate | 0.1-2 | | | | | | |
| (wt %) | | | | | | | |
| Iminodipropionate (wt %) | 0.1-5 | | | | | | |
| Water (wt %) | To 100 | To 100 | To 100 | To 100 | To 100 | To 100 | To 100 |
| 1% Blender Expansion | 6.1 | 5.4 | 6.2 | 9 | | 6.6 | 9.1 |
| Ratio | | | | | | | |
| 1% Blender QDT (min) | 12.83 | 10.15 | 8.77 | 6.2 | | 8.77 | 5.75 |
| 1% Wetting Test (s) | 10.12 | 11.11 | 9.19 | 11.04 | | 9.41 | 16.84 |

The following results are expansion ratio and drain time (minutes) testing results using a modified blender for the listed compositions.

| Composition | | 1 | 2 | 3 | 4 | 6 | 7 |
|---|---|---|---|---|---|---|---|
| 0.30% | Expansion Ratio | 2.93 | 3.08 | 3.68 | 3.8 | 2.53 | 3.6 |
| | Drain Time (min) | 4.32 | 4.38 | 5.89 | 5.58 | 3.46 | 4.5 |
| 0.60% | Expansion Ratio | 3.88 | 3.95 | 3.95 | 4.1 | 3.93 | 3.93 |
| | Drain Time (min) | 6.19 | 6.33 | 7.78 | 5.84 | 9.55 | 5.55 |

### EMBODIMENTS

For additional illustration, further and preferred embodiments of the present invention are set forth below.

Embodiment 1 is directed to a fluorine-free firefighting foam composition, the composition comprising: water; a surfactant component comprising: (i) one or more branched chain surfactants selected from anionic surfactants, amphoteric surfactants, and combinations thereof and (ii) one or more linear chain surfactants selected from anionic surfactants, amphoteric surfactants, and combinations thereof; a solvent component comprising one or more solvents, wherein the one or more solvents are selected from the group consisting of fatty alcohols, alcohols, glycols, glycol ethers, terpenes, and combinations thereof; wherein: the composition is in the form of a firefighting foam concentrate having a freezing point below 2° C. (35° F.); or the composition is in the form of a firefighting foam premix and the premix is a flowable liquid at temperatures of 0° C. or below, −10° C. or below, −20° C. or below, −30° C. or below, or −40° C. or below, and wherein: the weight ratio of branched chain surfactants to linear chain surfactants in the surfactant component is at least about 1:1, at least about 1.5:1, at least about 2:1, at least about 2.5:1, or at least about 3:1.

Embodiment 2 is directed to the composition of Embodiment 1 wherein the weight ratio of branched chain surfactants to linear chain surfactants in the surfactant component is less than about 5:1, less than about 3:1, or less than about 1.5:1.

Embodiment 3 is directed to the composition of Embodiment 1 or 2 wherein the surfactant component comprises at least about 0.5 wt % branched chain anionic surfactants, or from about 1.2 wt % to about 8 wt % branched chain anionic surfactants.

Embodiment 4 is directed to the composition of any one of Embodiments 1 to 3 wherein the branched chain anionic surfactants are selected from the group consisting of sulfate surfactants, ethoxylated sulfate surfactants, phosphate sulfate surfactants, and combinations thereof.

Embodiment 5 is directed to the composition of any one of Embodiments 1 to 4 wherein the surfactant component comprises at least about 0.5 wt % branched chain amphoteric/zwitterionic surfactants, or from about 1 wt % to about 20 wt % branched chain amphoteric/zwitterionic surfactants.

Embodiment 6 is directed to the composition of any one of Embodiments 1 to 5 wherein the branched chain amphoteric surfactants are selected from the group consisting of betaine surfactants, iminopropionate surfactants, sultaine surfactants, and combinations thereof.

Embodiment 7 is directed to the composition of any one of Embodiments 1 to 6 wherein the surfactant component comprises at least about 0.5 wt % linear chain anionic surfactants, or from about 8 wt % to about 55 wt % linear chain anionic surfactants.

Embodiment 8 is directed to the composition of any one of Embodiments 1 to 7 wherein the linear chain anionic surfactants are selected from the group consisting of sulfate surfactants, ethoxylated sulfate surfactants, phosphate sulfate surfactants, and combinations thereof.

Embodiment 9 is directed to the composition of any one of Embodiments 1 to 8 wherein the surfactant component comprises at least about 5 wt % linear chain amphoteric surfactants, or from about 8 wt % to about 35 wt % linear chain amphoteric surfactants.

Embodiment 10 is directed to the composition of any one of Embodiments 1 to 9 wherein the linear chain amphoteric surfactants are selected from the group consisting of betaine surfactants, iminopropionate surfactants, sultaine surfactants, and combinations thereof.

Embodiment 11 is directed to a fluorine-free firefighting foam composition, the composition comprising: water; a surfactant component comprising one or more anionic surfactants, one or more amphoteric surfactants, and combinations thereof; a solvent component comprising: (i) one or more branched chain solvents selected from the group consisting of fatty alcohols, alcohols, glycols, glycol ethers, and combinations thereof;

and (ii) one or more linear chain solvents selected from the group consisting of fatty alcohols, alcohols, glycols, glycol ethers, and combinations thereof; wherein: the composition is in the form of a firefighting foam concentrate having a freezing point below 2° C. (35° F.); or the composition is in the form of a firefighting foam premix that is a flowable liquid at temperatures of 0° C. or below, −10° C. or below, −20° C. or below, −30° C. or below, or −40° C. or below, and wherein: the weight ratio of branched chain solvents to linear chain solvents in the solvent component is at least about 1:1, at least about 1.5:1, at least about 2:1, at least about 2.5:1, or at least about 3:1.

Embodiment 12 is directed to the composition of Embodiment 11 wherein the weight ratio of branched chain solvents to linear chain solvents in the solvent component is less than about 5:1, less than about 2:1, or less than about 1.5:1.

Embodiment 13 is directed to the composition of Embodiment 11 or 12 wherein the branched solvents are selected from the group consisting of hexylene glycol, propylene glycol n-butyl ether (PnB), d-limonene, and combinations thereof.

Embodiment 14 is directed to the composition of any one of Embodiments 11 to 13 wherein the linear chain solvents are selected from the group consisting of butyl carbitol, ethylene glycol, polyethylene glycol, and combinations thereof.

Embodiment 15 is directed to a fluorine-free firefighting foam composition, the composition comprising: a surfactant component comprising one or more anionic surfactants, one or more amphoteric surfactants, and combinations thereof; a solvent component comprising one or more solvents, wherein the one or more solvents are selected from the group consisting of fatty alcohols, alcohols, glycols, glycol ethers, terpenes, and combinations thereof; wherein: the composition is in the form of a firefighting foam concentrate having a freezing point below 2° C. (35° F.); and/or the composition is in the form of a firefighting foam premix that is a flowable liquid at temperatures of 0° C. or below, −10° C. or below, −20° C. or below, −30° C. or below, or −40° C. or below, and wherein: the solvent component comprises one or more the following:
(i) one or more fatty alcohols, in a total proportion of from about 0.2 wt % to about 3.5 wt % of the solvent component, and/or
(ii) one or more alcohols, in a total proportion of from about 0.25 wt % to about 4.0 wt % of the solvent component, and/or
(iii) one or more glycols, in a total proportion of from about 5 wt % to about 30 wt % of the solvent component, and/or
(iv) one or more glycol ethers, in a total proportion of from about 2 wt % to about 20 wt % of the solvent component, and/or
(v) one or more terpenes (d-limonene) in a total proportion of from about 0.2 wt % to about 6 wt % of the solvent component.

Embodiment 16 is directed to the composition of any of Embodiments 1 to 15 wherein a foam premix contains from about 0.5 wt % to about 2 wt % of the composition of any of the preceding Embodiments, from about 30 wt % to about 60 wt % of a premix solvent, and water.

Embodiment 17 is directed to the composition of Embodiment 15 or 16, wherein: the fatty alcohols contain from 6 to 14 carbon atoms; the alcohols are selected from the group consisting of C6-C4 alkyl alcohol (linear and/or branched), and combinations thereof; the glycols are selected from the group consisting of propylene glycol, hexylene glycol, and combinations thereof; the glycol ethers are selected from the group consisting of butyl ether, 2-butoxyethanol, butyl carbitol, and combinations thereof; and the terpenes are selected from the group consisting of d-limonene, pinene, myrcene, terpinene, p-cymene, and combinations thereof.

Embodiment 18 is directed to the composition of any one of Embodiments 15 to 17, wherein the solvent component comprises:
(i)-(v); (i)-(iv), (i)-(iii), (i)-(ii), or (i);
(ii)-(v) (ii)-(iv), (ii)-(iii), or (ii);
(iii)-(v), (iii)-(iv), or (iii).
(iv)-(v); or (iv); or
(v).

Embodiment 19 is directed to the composition of any one of Embodiments 15 to 18 wherein the composition is free of any organic or inorganic salt.

Embodiment 20 is directed to a fluorine-free firefighting foam concentrate composition, the composition comprising: water; a surfactant component comprising one or more anionic surfactants, one or more amphoteric surfactants, and combinations thereof; a solvent component comprising d-limonene and one or more solvents are selected from the group consisting of fatty alcohols, glycols, glycol ethers, and combinations thereof; wherein: d-limonene constitutes from about 0.1 wt % to about 2 wt % of the foam concentrate.

Embodiment 21 is directed to the composition of Embodiment 20, wherein the composition further comprises a glycol ether solvent selected from the group consisting of butyl carbitol, propylene glycol n-butyl ether (PnB), and combinations thereof.

Embodiment 22 is directed to the composition of Embodiment 20 or 21 wherein the composition comprises: from about 0.1 to about 1.0 wt % fatty alcohols; from about 15 wt % to about 30 wt % of glycol ether solvents; from about 30 wt % to about 40 wt % amphoteric surfactants; and from about 15 wt % to about 25 wt % of anionic surfactants.

Embodiment 23 is directed to the composition of Embodiment 20 or 21 wherein the composition comprises: from about 15 wt % to about 30 wt % of glycol ether solvents; from about 20 wt % to about 30 wt % of amphoteric surfactants; and from about 20 wt % to about 30 wt % of anionic surfactants.

Embodiment 24 is directed to the composition of Embodiment 20 or 21 wherein the composition comprises: from about 0.1 to about 2.5 wt % fatty alcohols; from about 15 wt % to about 30 wt % of glycol ether solvents; from about 10 wt % to about 20 wt % amphoteric surfactants; and from about 45 wt % to about 65 wt % of anionic surfactants.

Embodiment 25 is directed to the composition of Embodiment 20 or 21 wherein the composition comprises: from about 0.1 to about 3.5 wt % fatty alcohols; from about 15 wt % to about 30 wt % of glycol ether solvents; and from about 45 wt % to about 65 wt % of anionic surfactants.

Embodiment 26 is directed to a fluorine-free firefighting foam concentrate composition, the composition comprising: water; a surfactant component comprising one or more anionic surfactants, one or more amphoteric surfactants, and combinations thereof; a solvent component comprising one or more solvents are selected from the group consisting of fatty alcohols, glycols, glycol ethers, terpenes, and combinations thereof; wherein: anionic surfactants constitute at least about 50 wt % of the surfactant component.

Embodiment 27 is directed to a fluorine-free firefighting foam concentrate composition, the composition comprising: water; a surfactant component comprising one or more anionic surfactants, one or more amphoteric surfactants, and combinations thereof; a solvent component comprising one or more solvents are selected from the group consisting of fatty alcohols, glycols, glycol ethers, terpenes, and combinations thereof; wherein: the weight ratio of anionic surfactant to amphoteric surfactant in the surfactant component is from about 60:40 to about 40:60, from about 55:45 to about 45:55, or about 50:50.

Embodiment 28 is directed to the composition of Embodiment 27, wherein the surfactant component constitutes at least about 70 wt %, at least about 75 wt %, at least about 80 wt %, or at least about 85 wt % of the composition.

Embodiment 29 is directed to a fluorine-free firefighting foam concentrate composition, the composition comprising: water; d-limonene in a proportion of from about 0.1 wt % to about 10 wt % of the concentrate; a surfactant component comprising one or more anionic surfactants, one or more amphoteric surfactants, and combinations thereof; and a solvent component comprising one or more solvents selected from the group consisting of fatty alcohols, glycols, glycol ethers, and combinations thereof, wherein the composition comprises: from about 0.1 wt % to about 5 wt % of one or more alcohol or fatty alcohols; from about 1 wt % to about 60 wt % of glycol ether solvents; from about 25 wt % to about 60 wt % of anionic surfactants; and from about 10 wt % to about 40 wt % amphoteric surfactants; and wherein the composition exhibits 1% Drave Test Wetting Results of at least 8 seconds(s).

Embodiment 30 is directed to a fluorine-free high expansion firefighting foam, the composition comprising: a surfactant component consisting of one or more anionic surfactants, and one or more amphoteric surfactants, wherein the anionic surfactants constitute from about 15 wt % to about 60 wt % of the composition, and the amphoteric surfactants constitute from about 20 wt % to about 50 wt % of the composition; and the composition exhibits an expansion ratio of at least about 200, at least about 400, at least about 600, or at least about 800.

Embodiment 31 is directed to a fluorine-free firefighting foam concentrate composition, the composition comprising: water; d-limonene in a proportion of from about 0.1 wt % to about 3 wt % of the concentrate; a surfactant component comprising one or more anionic surfactants, one or more amphoteric surfactants, and combinations thereof; and a solvent component comprising one or more solvents selected from the group consisting of fatty alcohols, glycols, glycol ethers, and combinations thereof, wherein the composition comprises: from about 0.1 wt % to about 5 wt % of one or more alcohols or fatty alcohols; from about 1 wt % to about 60 wt % of glycol ether solvents; from about 1 wt % to about 10 wt % of anionic surfactants; and from about 10 wt % to about 60 wt % amphoteric surfactants; and wherein the concentrate composition passes Vehicle system fire testing conducted at −40° C.

Embodiment 32 is directed to a fluorine-free firefighting foam concentrate composition, the composition comprising: water; d-limonene in a proportion of from about 0.1 wt % to about 3 wt % of the concentrate; a surfactant component consisting of one or more amphoteric surfactants, and combinations thereof; and a solvent component comprising one or more solvents selected from the group consisting of fatty alcohols, glycols, glycol ethers, and combinations thereof, wherein the composition comprises: from about 0.1 wt % to about 5 wt % of one or more alcohols or fatty alcohols; from about 1 wt % to about 60 wt % of glycol ether solvents; and from about 10 wt % to about 60 wt % amphoteric surfactants; and wherein the concentrate composition passes Vehicle system fire testing conducted at −40° C.

Embodiment 33 is directed to a firefighting foam premix, the premix containing from about 0.5 wt % to about 2 wt % of the composition of any of the preceding Embodiments, from about 30 wt % to about 60 wt % of a premix solvent, and water, wherein the premix is a flowable liquid below temperatures of 0° C., −10° C., −20° C., −30° C., or −40° C.

Embodiment 34 is the premix of Embodiment 33 containing approximately 1 wt % of the composition of any of Embodiments 1 to 32.

Embodiment 35 is the premix of Embodiment 33 or 34 wherein water constitutes from about 40 wt % to about 70 wt %.

Example embodiments have been provided so that this disclosure will be thorough, and will fully convey the scope to those who are skilled in the art. Numerous specific details are set forth such as examples of specific components, methods, etc. to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes and well-known technologies are not described in detail.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element or component could be termed a second element or component without departing from the teachings of the example embodiments.

In view of the above, it will be seen that the several objects of the invention are achieved, and other advantageous results attained.

As various changes could be made in the above without departing from the scope of the present disclosure, it is intended that all matter contained in the above description shall be interpreted as illustrative and not in a limiting sense.

Having described the present disclosure in detail, it will be apparent that modifications and variations are possible without departing from the scope of the present disclosure defined in the appended claims.

1. A fluorine-free firefighting foam composition, the composition comprising:
water;
a surfactant component comprising: (i) one or more branched chain surfactants selected from anionic surfactants, amphoteric surfactants, and combinations thereof and (ii) one or more linear chain surfactants selected from anionic surfactants, amphoteric surfactants, and combinations thereof;
a solvent component comprising one or more solvents, wherein the one or more solvents are selected from the group consisting of fatty alcohols, alcohols, glycols, glycol ethers, terpenes, and combinations thereof; wherein:
the composition is in the form of a firefighting foam concentrate having a freezing point below 2° C. (35° F.); or
the composition is in the form of a firefighting foam premix and the premix is a flowable liquid at temperatures of 0° C. or below, −10° C. or below, −20° C. or below, −30° C. or below, or −40° C. or below, and wherein:
the weight ratio of branched chain surfactants to linear chain surfactants in the surfactant component is at least about 1:1, at least about 1.5:1, at least about 2:1, at least about 2.5:1, or at least about 3:1.

2. The composition of claim 1 wherein the weight ratio of branched chain surfactants to linear chain surfactants in the surfactant component is less than about 5:1, less than about 3:1, or less than about 1.5:1.

3. The composition of claim 1 wherein the surfactant component comprises at least about 0.5 wt % branched chain anionic surfactants, or from about 1.2 wt % to about 8 wt % branched chain anionic surfactants.

4. The composition of claim 1 wherein the branched chain anionic surfactants are selected from the group consisting of sulfate surfactants, ethoxylated sulfate surfactants, phosphate sulfate surfactants, and combinations thereof.

5. The composition of claim 1 wherein the surfactant component comprises at least about 0.5 wt % branched chain amphoteric/zwitterionic surfactants, or from about 1 wt % to about 20 wt % branched chain amphoteric/zwitterionic surfactants.

6. The composition of claim 1 wherein the branched chain amphoteric surfactants are selected from the group consisting of betaine surfactants, iminopropionate surfactants, sultaine surfactants, and combinations thereof.

7. The composition of claim 1 wherein the surfactant component comprises at least about 0.5 wt % linear chain anionic surfactants, or from about 8 wt % to about 55 wt % linear chain anionic surfactants.

8. The composition of claim 1 wherein the linear chain anionic surfactants are selected from the group consisting of sulfate surfactants, ethoxylated sulfate surfactants, phosphate sulfate surfactants, and combinations thereof.

9. The composition of claim 1 wherein the surfactant component comprises at least about 5 wt % linear chain amphoteric surfactants, or from about 8 wt % to about 35 wt % linear chain amphoteric surfactants.

10. The composition of claim 1 wherein the linear chain amphoteric surfactants are selected from the group consisting of betaine surfactants, iminopropionate surfactants, sultaine surfactants, and combinations thereof.

11. A fluorine-free firefighting foam composition, the composition comprising:
water;
a surfactant component comprising one or more anionic surfactants, one or more amphoteric surfactants, and combinations thereof;
a solvent component comprising: (i) one or more branched chain solvents selected from the group consisting of fatty alcohols, alcohols, glycols, glycol ethers, and combinations thereof; and (ii) one or more linear chain solvents selected from the group consisting of fatty alcohols, alcohols, glycols, glycol ethers, and combinations thereof;
wherein:
the composition is in the form of a firefighting foam concentrate having a freezing point below 2° C. (35° F.); or
the composition is in the form of a firefighting foam premix that is a flowable liquid at temperatures of 0° C. or below, −10° C. or below, −20° C. or below, −30° C. or below, or −40° C. or below, and wherein:
the weight ratio of branched chain solvents to linear chain solvents in the solvent component is at least about 1:1, at least about 1.5:1, at least about 2:1, at least about 2.5:1, or at least about 3:1.

12. The composition of claim 11 wherein the weight ratio of branched chain solvents to linear chain solvents in the solvent component is less than about 5:1, less than about 2:1, or less than about 1.5:1.

13. The composition of claim 11 wherein the branched solvents are selected from the group consisting of hexylene glycol, propylene glycol n-butyl ether (PnB), d-limonene, and combinations thereof.

14. The composition of claim 11 wherein the linear chain solvents are selected from the group consisting of butyl carbitol, ethylene glycol, polyethylene glycol, and combinations thereof.

15. A fluorine-free firefighting foam composition, the composition comprising:
a surfactant component comprising one or more anionic surfactants, one or more amphoteric surfactants, and combinations thereof;
a solvent component comprising one or more solvents, wherein the one or more solvents are selected from the group consisting of fatty alcohols, alcohols, glycols, glycol ethers, terpenes, and combinations thereof; wherein:
the composition is in the form of a firefighting foam concentrate having a freezing point below 2° C. (35° F.); and/or
the composition is in the form of a firefighting foam premix that is a flowable liquid at temperatures of 0° C. or below, −10° C. or below, −20° C. or below, −30° C. or below, or −40° C. or below, and wherein:
the solvent component comprises one or more the following:
(i) one or more fatty alcohols, in a total proportion of from about 0.2 wt % to about 3.5 wt % of the solvent component, and/or
(ii) one or more alcohols, in a total proportion of from about 0.25 wt % to about 4.0 wt % of the solvent component, and/or
(iii) one or more glycols, in a total proportion of from about 5 wt % to about 30 wt % of the solvent component, and/or
(iv) one or more glycol ethers, in a total proportion of from about 2 wt % to about 20 wt % of the solvent component, and/or
(v) one or more terpenes (d-limonene) in a total proportion of from about 0.2 wt % to about 6 wt % of the solvent component.

16. The composition of any of claims 1 to 15 wherein a foam premix contains from about 0.5 wt % to about 2 wt % of the composition of any of the preceding claims, from about 30 wt % to about 60 wt % of a premix solvent, and water.

17. The composition of claim 15 or 16 wherein:
the fatty alcohols contain from 6 to 14 carbon atoms;
the alcohols are selected from the group consisting of C6-C4 alkyl alcohol (linear and/or branched), and combinations thereof;
the glycols are selected from the group consisting of propylene glycol, hexylene glycol, and combinations thereof;
the glycol ethers are selected from the group consisting of butyl ether, 2-butoxyethanol, butyl carbitol, and combinations thereof; and
the terpenes are selected from the group consisting of d-limonene, pinene, myrcene, terpinene, p-cymene, and combinations thereof.

18. The composition of any one of claims 15 to 17, wherein the solvent component comprises:
(i)-(v); (i)-(iv), (i)-(iii), (i)-(ii), or (i);
(ii)-(v) (ii)-(iv), (ii)-(iii), or (ii);
(iii)-(v), (iii)-(iv), or (iii),
(iv)-(v); or (iv); or
(v).

19. The composition of any one of claims 15 to 18 wherein the composition is free of any organic or inorganic salt.

20. A fluorine-free firefighting foam concentrate composition, the composition comprising:
water;
a surfactant component comprising one or more anionic surfactants, one or more amphoteric surfactants, and combinations thereof;
a solvent component comprising d-limonene and one or more solvents selected from the group consisting of fatty alcohols, glycols, glycol ethers, and combinations thereof;
wherein:
d-limonene constitutes from about 0.1 wt % to about 2 wt % of the foam concentrate.

21. The composition of claim 20, wherein the composition further comprises a glycol ether solvent selected from the group consisting of butyl carbitol, propylene glycol n-butyl ether (PnB), and combinations thereof.

22. The composition of claim 20 wherein the composition comprises:
from about 0.1 to about 1.0 wt % fatty alcohols;
from about 15 wt % to about 30 wt % of glycol ether solvents;
from about 30 wt % to about 40 wt % amphoteric surfactants; and
from about 15 wt % to about 25 wt % of anionic surfactants.

23. The composition of claim 20 wherein the composition comprises:
from about 15 wt % to about 30 wt % of glycol ether solvents;
from about 20 wt % to about 30 wt % amphoteric surfactants; and
from about 20 wt % to about 30 wt % of anionic surfactants.

24. The composition of claim 20 wherein the composition comprises:
from about 0.1 to about 2.5 wt % fatty alcohols;
from about 15 wt % to about 30 wt % of glycol ether solvents;
from about 10 wt % to about 20 wt % amphoteric surfactants; and
from about 45 wt % to about 65 wt % of anionic surfactants.

25. The composition of claim 20 wherein the composition comprises:
from about 0.1 to about 3.5 wt % fatty alcohols;
from about 15 wt % to about 30 wt % of glycol ether solvents; and
from about 45 wt % to about 65 wt % of anionic surfactants.

26. A fluorine-free firefighting foam concentrate composition, the composition comprising:
water;
a surfactant component comprising one or more anionic surfactants, one or more amphoteric surfactants, and combinations thereof;
a solvent component comprising one or more solvents selected from the group consisting of fatty alcohols, glycols, glycol ethers, terpenes, and combinations thereof;
wherein:
anionic surfactants constitute at least about 50 wt % of the surfactant component.

27. A fluorine-free firefighting foam concentrate composition, the composition comprising:
water;
a surfactant component comprising one or more anionic surfactants, one or more amphoteric surfactants, and combinations thereof;
a solvent component comprising one or more solvents are selected from the group consisting of fatty alcohols, glycols, glycol ethers, terpenes, and combinations thereof;
wherein:
the weight ratio of anionic surfactant to amphoteric surfactant in the surfactant component is from about 60:40 to about 40:60, from about 55:45 to about 45:55, or about 50:50.

28. The composition of claim 27, wherein the surfactant component constitutes at least about 70 wt %, at least about 75 wt %, at least about 80 wt %, or at least about 85 wt % of the composition.

29. A fluorine-free firefighting foam concentrate composition, the composition comprising:
water;
d-limonene in a proportion of from about 0.1 wt % to about 10 wt % of the concentrate;
a surfactant component comprising one or more anionic surfactants, one or more amphoteric surfactants, and combinations thereof; and
a solvent component comprising one or more solvents selected from the group consisting of fatty alcohols, glycols, glycol ethers, and combinations thereof, wherein the composition comprises:
from about 0.1 wt % to about 5 wt % of one or more alcohol or fatty alcohols;
from about 1 wt % to about 60 wt % of glycol ether solvents;
from about 25 wt % to about 60 wt % of anionic surfactants; and
from about 10 wt % to about 40 wt % amphoteric surfactants; and
wherein the composition exhibits 1% Drave Test Wetting Results of at least 8 seconds(s).

30. A fluorine-free high expansion firefighting foam, the composition comprising:
a surfactant component consisting of one or more anionic surfactants, and one or more amphoteric surfactants, wherein the anionic surfactants constitute from about 15 wt % to about 60 wt % of the composition, and the amphoteric surfactants constitute from about 20 wt % to about 50 wt % of the composition; and
the composition exhibits an expansion ratio of at least about 200, at least about 400, at least about 600, or at least about 800.

31. A fluorine-free firefighting foam concentrate composition, the composition comprising:
water;
d-limonene in a proportion of from about 0.1 wt % to about 3 wt % of the concentrate;
a surfactant component comprising one or more anionic surfactants, one or more amphoteric surfactants, and combinations thereof; and
a solvent component comprising one or more solvents selected from the group consisting of fatty alcohols, glycols, glycol ethers, and combinations thereof, wherein the composition comprises:
from about 0.1 wt % to about 5 wt % of one or more alcohols or fatty alcohols;
from about 1 wt % to about 60 wt % of glycol ether solvents;
from about 1 wt % to about 10 wt % of anionic surfactants; and
from about 10 wt % to about 60 wt % amphoteric surfactants; and
wherein the concentrate composition passes Vehicle system fire testing conducted at −40° C.

32. A fluorine-free firefighting foam concentrate composition, the composition comprising:
water;
d-limonene in a proportion of from about 0.1 wt % to about 3 wt % of the concentrate; a surfactant component consisting of one or more amphoteric surfactants, and combinations thereof; and
a solvent component comprising one or more solvents selected from the group consisting of fatty alcohols, glycols, glycol ethers, and combinations thereof, wherein the composition comprises:
from about 0.1 wt % to about 5 wt % of one or more alcohols or fatty alcohols;
from about 1 wt % to about 60 wt % of glycol ether solvents; and
from about 10 wt % to about 60 wt % amphoteric surfactants; and
wherein the concentrate composition passes Vehicle system fire testing conducted at −40° C.

33. A firefighting foam premix, the premix containing from about 0.5 wt % to about 2 wt % of the composition of any of the preceding claims, from about 30 wt % to about 60 wt % of a premix solvent, and water, wherein the premix is a flowable liquid below temperatures of 0° C., −10° C., −20° C., −30° C., or −40° C.

34. The premix of claim 33 containing approximately 1 wt % of the composition of any of claims 1 to 32.

35. The premix of claim 33 or 34 wherein water constitutes from about 40 wt % to about 70 wt %.
